(19) United States
(12) Patent Application Publication
(10) Pub. No.: US 2023/0260591 A1
(43) Pub. Date: Aug. 17, 2023

(54) TRANSFORMING LOCAL WIRE THRU RESISTANCES INTO GLOBAL DISTRIBUTED RESISTANCES

(71) Applicant: SYNOPSYS, INC., Mountain View, CA (US)

(72) Inventors: Jeffrey Herbert, Napels, FL (US); John Edward Barth, JR., Williston, VT (US); Matthew Christopher Lanahan, East Fairfield, VT (US)

(21) Appl. No.: 18/107,452

(22) Filed: Feb. 8, 2023

Related U.S. Application Data
(60) Provisional application No. 63/310,419, filed on Feb. 15, 2022.

(51) Int. Cl. G11C 29/54; G06F 30/367; G06F 30/3308

(52) U.S. Cl. CPC G11C 29/54; G06F 30/367; G06F 30/3308

(57) ABSTRACT

A method for transient analysis of a memory module circuit, the method including: determining port to port resistances between terminals of internal circuits of a plurality of leaf cells of a netlist representing the memory module circuit; generating a plurality of equivalent networks corresponding to the internal circuits of the leaf cells, the equivalent networks being connected to each other; promoting the equivalent networks of the leaf cells to a hierarchical level above the leaf cells in the netlist representing the memory module circuit; shorting one or more terminals of each of the leaf cells to a central node of a corresponding one of the equivalent networks; and performing the transient analysis of the leaf cells of the netlist representing the memory module circuit.

### RELATED APPLICATION

This application claims priority to and the benefit of U.S. Provisional Patent Application No. 63/310,419, filed on Feb. 15, 2022, in the United States Patent and Trademark Office, the entire disclosure of which is incorporated by reference herein.

### TECHNICAL FIELD

The present disclosure relates to the field of integrated circuit (IC) design and electronic design automation (EDA). More specifically, the present disclosure is related to a system and method for transforming local wire thru resistances into global distributed resistances.

### BACKGROUND

Circuit simulation is a process in which a model of an electronic circuit is created and analyzed using various software algorithms that predict and verify the behavior and performance of the circuit. Because the fabrication of electronic circuits, especially integrated circuits (ICs), is expensive and time-consuming, it is faster and more cost-effective to verify the behavior and performance of the circuit using a circuit simulator before fabrication.

Circuit designers rely on simulating their design to, for example, validate the timing performance of a circuit design. Traditional transient analysis of memory compiler instances consumes massive computational resources during timing rule characterization through simulation. Further, timing rule generation through circuit simulation requires the construction of input stimuli in the form of vectors and output measurement statements to capture and verify timings. Static timing analysis, in contrast, is less resource intensive and can provide feedback to a circuit designer more quickly, but the results of these static timing analyses can be less accurate than the results from a simulation.

The above information disclosed in this Background section is only for enhancement of understanding of the background of the invention and therefore it may contain information that does not constitute prior art.

### SUMMARY

This summary is provided to introduce a selection of features and concepts of embodiments of the present disclosure that are further described below in the detailed description. This summary is not intended to identify key or essential features of the claimed subject matter, nor is it intended to be used in limiting the scope of the claimed subject matter. One or more of the described features may be combined with one or more other described features to provide a workable device.

In one or more embodiments, a method for transient analysis of a memory module circuit includes: determining port to port resistances between terminals of internal circuits of a plurality of leaf cells of a netlist representing the memory module circuit; generating a plurality of equivalent networks corresponding to the internal circuits of the leaf cells, the equivalent networks being connected to each other; promoting the equivalent networks of the leaf cells to a hierarchical level above the leaf cells in the netlist representing the memory module circuit; shorting one or more terminals of each of the leaf cells to a central node of a corresponding one of the equivalent networks; and performing the transient analysis of the leaf cells of the netlist representing the memory module circuit.

In one or more embodiments, the internal circuits of the leaf cells include one or more parasitic resistances of the leaf cells, and wherein the equivalent networks include one or more equivalent resistances corresponding to the one or more parasitic resistances of the leaf cells.

In one or more embodiments, promoting the equivalent networks of the leaf cells includes connecting the one or more equivalent resistances corresponding to the one or more parasitic resistances of the leaf cells outside the leaf cells at inputs of the leaf cells.

In one or more embodiments, the port to port resistances between the terminals of the internal circuits of the leaf cells are determined based on a DC simulation of the leaf cells by: applying a voltage between a first terminal and a second terminal of each of the internal circuits of the leaf cells to determine an applied voltage and floating one or more other terminals of each of the internal circuits of the leaf cells; measuring a current between the first and second terminals of each of the internal circuits of the leaf cells to determine a measured current; measuring a voltage at one of the one or more floated terminals of each of the internal circuits of the leaf cells to determine a measured voltage; determining a first resistance value between the first and second terminals by dividing the measured voltage by the measured current; and determining a second resistance value between the first and second terminals by dividing the applied voltage by the measured current and subtracting the first resistance value from a result from the division.

In one or more embodiments, method further includes: applying a voltage between a third terminal and a fourth terminal of each of the internal circuits of the leaf cells to determine a second applied voltage and floating one or more of the first and second terminals of each of the internal circuits of the leaf cells; measuring a current between the third and fourth terminals of each of the internal circuits of the leaf cells to determine a second measured current; measuring a voltage at one of the one or more floated first and second terminals of each of the internal circuits of the leaf cells to determine a second measured voltage; determining a third resistance value between the third and fourth terminals by dividing the second measured voltage by the second measured current; and determining a fourth resistance value between the third and fourth terminals by dividing the second applied voltage by the second measured current and subtracting the third resistance value from a second result from the division.

In one or more embodiments, the method further includes: determining that an internal circuit from among the internal circuits of the leaf cells is missing a third terminal; applying a voltage between a counter-clockwise terminal from among the first terminal, the second terminal, and a fourth terminal of the internal circuit of the leaf cell and a terminal from among the first, second, and third terminals that is across from the missing third terminal, the counter-clockwise terminal being in a counter-clockwise position from the missing third terminal; measuring a current between the counter-clockwise terminal and the terminal across from the missing third terminal; measuring a voltage at a clockwise terminal from among the first, second, and fourth terminals, the clockwise terminal being in a clockwise position from the missing third terminal; and determining a resistance of the terminal across from the missing third terminal by dividing the voltage at the clockwise terminal by the current between the counter-clockwise terminal and the terminal across from the missing third terminal, and subtracting a resistance of the counter-clockwise terminal from a third result of the division.

In one or more embodiments, a system for transient analysis of a memory module circuit includes: a memory storing instructions; and a processor, coupled with the memory and to execute the instructions, the instructions when executed cause the processor to: remove one or more transistors and capacitors in each of a plurality of leaf cells of a netlist representing the memory module circuit; iteratively reduce number of resistors in each of the leaf cells by at least removing dangling resistors; generate equivalent networks corresponding to internal circuits of the leaf cells; promote the equivalent networks of the leaf cells to a hierarchical level above the leaf cells in the memory module circuit; and perform the transient analysis of the leaf cells of the netlist representing the memory module circuit.

In one or more embodiments, the processor is further configured to: determine the internal circuits of the leaf cells, each of the internal circuits including one or more remaining resistors after the iterative reduction of the resistors in each of the leaf cells.

In one or more embodiments, a total number of resistors in each of the leaf cells are further iteratively reduced by combining serial, parallel, and triode resistor configurations in the internal circuits of each of the leaf cells.

In one or more embodiments, processor is further configured to: determine port to port resistances between terminals of the internal circuits of the leaf cells; and short one or more terminals of each of the leaf cells to a central node of a corresponding one of the equivalent networks.

In one or more embodiments, the equivalent networks corresponding to the internal circuits of the leaf cells are generated based on the port to port resistances between the terminals of the internal circuits of the leaf cells.

In one or more embodiments, the internal circuits of the leaf cells include one or more parasitic resistances of the leaf cells, and wherein the equivalent networks include one or more equivalent resistances corresponding to the one or more parasitic resistances of the leaf cells.

In one or more embodiments, promoting the equivalent networks of the leaf cells includes connecting the one or more equivalent resistances corresponding to the one or more parasitic resistances of the leaf cells outside the leaf cells at an input of each of the leaf cells.

In one or more embodiments, to determine the port to port resistances between the terminals of the internal circuits of the leaf cells based on a DC simulation of the leaf cells, the processor is configured to: apply a voltage between a first terminal and a second terminal of each of the internal circuits of the leaf cells to determine an applied voltage; float one or more other terminals of each of the internal circuits of the leaf cells; measure a current between the first and second terminals of each of the internal circuits of the leaf cells to determine a measured current; and measure a voltage at one of the one or more floated terminals of each of the internal circuits of the leaf cells to determine a measured voltage.

In one or more embodiments, the processor is further configured to: determine a first resistance value between the first and second terminals by dividing the measured voltage by the measured current; and determine a second resistance value between the first and second terminals by dividing the applied voltage by the measured current and subtracting the first resistance value from a result from the division.

In one or more embodiments, the processor is further configured to: apply a voltage between a third terminal and a fourth terminal of each of the internal circuits of the leaf cells to determine a second applied voltage; float one or more of the first terminal and the second terminal of each of the internal circuits of the leaf cells; measure a current between the third and fourth terminals of each of the internal circuits of the leaf cells to determine a second measured current; measure a voltage at one of the one or more floated first and second terminals of each of the internal circuits of the leaf cells to determine a second measured voltage; determine a third resistance value between the third and fourth terminals by dividing the second measured voltage by the second measured current; and determine a fourth resistance value between the third and fourth terminals by dividing the second applied voltage by the second measured current and subtracting the third resistance value from a second result from the division.

In one or more embodiments, the processor is further configured to: determine that an internal circuit from among the internal circuits of the leaf cells is missing a third terminal; apply a voltage between a counter-clockwise terminal from among the first terminal, the second terminal, and a fourth terminal of the internal circuit of the leaf cell and a terminal from among the first, second, and third terminals that is across from the missing third terminal, the counter-clockwise terminal being in a counter-clockwise position from the missing third terminal; measure a current between the counter-clockwise terminal and the terminal across from the missing third terminal; measure a voltage at a clockwise terminal from among the first, second, and fourth terminals, the clockwise terminal being in a clockwise position from the missing third terminal; and determine a resistance of the terminal across from the missing third terminal by dividing the voltage at the clockwise terminal by the current between the counter-clockwise terminal and the terminal across from the missing third terminal, and subtracting a resistance of the counter-clockwise terminal from a third result of the division.

In one or more embodiments, a non-transitory computer readable medium including stored instructions, which when executed by a processor, cause the processor to: generate equivalent networks corresponding to internal circuits of a plurality of leaf cells of a netlist representing a memory module circuit; promote the equivalent networks of the leaf cells to a hierarchical level above the leaf cells in the memory module circuit; and perform a transient analysis of the leaf cells of the netlist representing the memory module circuit.

In one or more embodiments, the processor is further configured to: determine port to port resistances between terminals of the internal circuits of the leaf cells; and short one or more terminals of each of the leaf cells to a central node of a corresponding one of the equivalent networks, wherein the internal circuits of the leaf cells include one or more parasitic resistances of the leaf cells, wherein the equivalent networks include one or more equivalent resistances corresponding to the one or more parasitic resistances of the leaf cells, and wherein promoting the equivalent networks of the leaf cells include connecting the one or more equivalent resistances corresponding to the one or more parasitic resistances of the leaf cells outside the leaf cells at inputs of the leaf cells.

In one or more embodiments, to determining the port to port resistances between the terminals of the internal circuits of the leaf cells based on a DC simulation of the leaf cells, the processor is further configured to: apply a voltage between a first terminal and a second terminal of each of the internal circuits of the leaf cells to determine an applied voltage; float one or more other terminals of each of the internal circuits of the leaf cells; measure a current between the first and second terminals of each of the internal circuits of the leaf cells to determine a measured current; measure a voltage at one of the one or more floated terminals of each of the internal circuits of the leaf cells to determine a measured voltage; determine a first resistance value between the first and second terminals by dividing the measured voltage by the measured current; and determine a second resistance value between the first and second terminals by dividing the applied voltage by the measured current and subtracting the first resistance value from a result from the division.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1A illustrates an example logical netlist representing a memory module generated by a memory compiler.

FIG. 1B illustrates the netlist of FIG. 1A with extracted leaf cells.

FIG. 1C illustrates the netlist of FIG. 1A where the internal parasitic resistances of the leaf cells are isolated into separate resistances according to an embodiment of the present disclosure.

FIG. 2 illustrates a method for determining equivalent resistances of a leaf cell of a netlist of a memory module and promoting the equivalent resistances to a hierarchical level above the leaf cell according to one embodiment of the present disclosure.

FIG. 3 illustrates a netlist with a plurality of extracted leaf cells according to one embodiment of the present disclosure.

FIG. 4A illustrates a method for determining values of parasitic resistances inside a leaf cell according to one embodiment of the present disclosure.

FIG. 4B illustrates a method of determining a resistance at the pin across from a missing pin in a leaf cell according to one embodiment of the present disclosure.

FIGS. 5 illustrate a circuit and FIG. 6 illustrates a flowchart of a method to transform local wire through resistances into global distributed resistances in a logical netlist of leaf cells according to one embodiment of the present disclosure.

FIG. 7 depicts a flowchart of various processes used during the design and manufacture of an integrated circuit in accordance with one or more embodiments of the present disclosure.

FIG. 8 depicts a diagram of an example computer system in which embodiments of the present disclosure may operate.

### DETAILED DESCRIPTION

Aspects of the present disclosure relate to transforming local wire thru resistances into global distributed resistances.

The memory content of System-on-Chip (SoC) designs has increased dramatically over the past few years. More and more silicon area consists of memories with different functionality in the forms of embedded SRAM, ROM, and multi-port register files, or the like. The embedded memories in a SoC may provide improved performance, lower power consumption, on-demand memory activation with refined standby modes, more compact packaging, and overall cost reduction. On the other hand, embedded memories may increase the design complexity due to area and yield optimization challenges.

Embedded memory characterization is of increasing concern to SoC designers. Accuracy and efficiency of the models at all stages of the design are essential to the success of designing a SoC with embedded memories. The number of memory instances per chip increases rapidly as feature sizes shrink in successive process nodes. To simulate the full range of process, voltage, and temperature corners (PVTs) and the effects of process variation, the number of memory characterization runs, and the data processing time per run may grow exponentially.

There are two general approaches to creating memory models. The first approach is based on the characterization of memory compiler generated models, while the second approach is based on the characterization of individual memory instances. Because the number of possible memory configurations and parameters an end user may want may vary widely, it is impossible to pre-build all combinations. Therefore, electronic design automation systems provide memory compilers that can automate the creation of many different and unique memories very quickly. The characterization is done by fitting timing data to polynomial equations with their coefficients derived from a small sample of memory instances. The advantage of this approach is that the model generation is very fast, but it comes at a cost of less than optimum accuracy.

A significant amount of the engineering effort and time performing memory characterization is focused on timing analysis and model generation. Timing verification is the process of validating that a design meets its design specifications by operating at a specific clock frequency without errors caused by a signal arriving too soon or too late.

Transistor-level static timing analysis may be more desirable over the traditional black-box approach timing analysis. Static timing analysis (STA) is a method of validating the timing performance of a design by checking all possible paths for timing violations. STA breaks a design down into timing paths, calculates the signal propagation delay along each path, and checks for violations of timing constraints inside the design and at the input/output interface. Unlike dynamic simulators, STA tools remove the need for simulating the entire memory circuit under all possible scenarios. Instead, STA tools use fast but accurate approaches to estimate the delay of sub-circuits within the memory circuit and use graph analysis techniques to quickly seek out the slowest and fastest paths (critical paths) in the memory circuit. The result is that an STA tool can typically find all timing violations in a memory circuit in a fraction of the time it would take a dynamic circuit simulator.

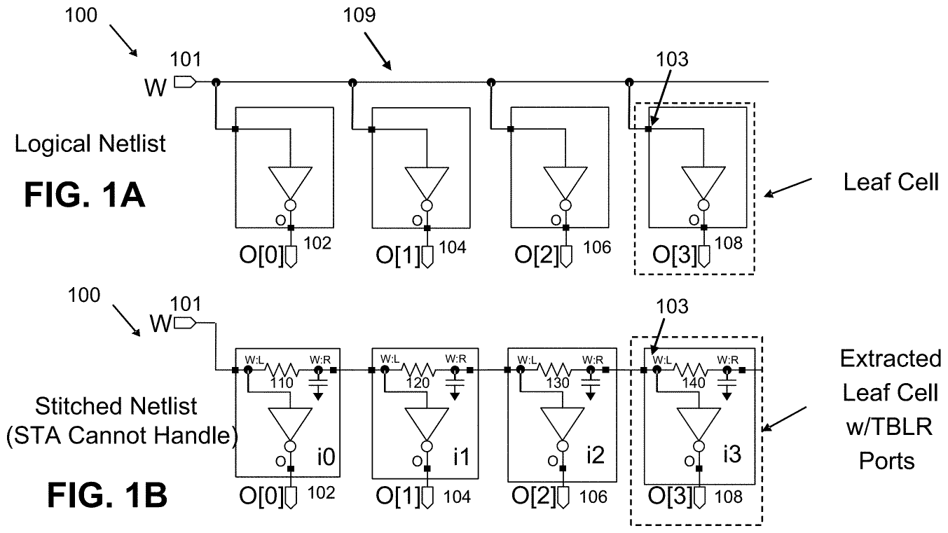

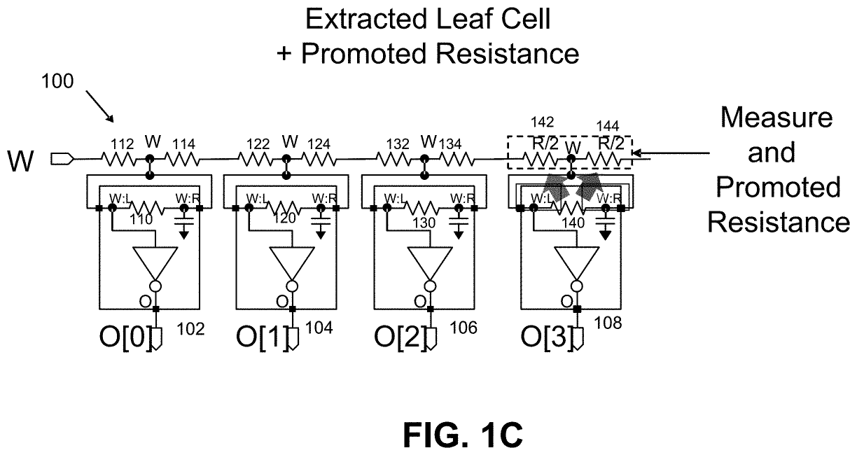

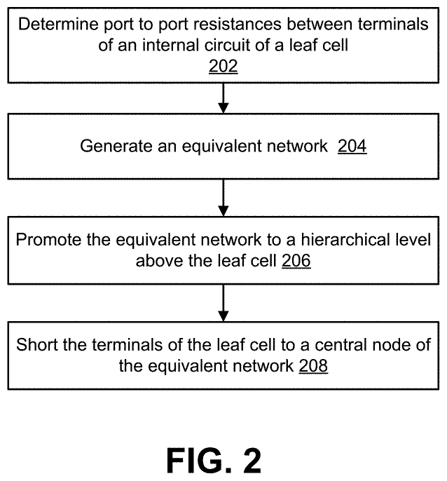

Although STA tools are much faster than simulation and do not require input vectors or measurements, STA tools do not recognize or take into consideration wire-thru resistances inside leaf cells, where the input load is modulated by the output load, making it difficult to characterize leaf cell delay, as will be described in more detail below with respect to FIG. 1A and FIG. 1B. A leaf cell is an atomic unit used to construct a memory instance.

One or more embodiments of the present disclosure relate to transforming local wire thru resistances into global distributed resistances. According to some aspects, the present disclosure provides transforming local wire thru resistances into global distributed resistances by either measuring port-to-port resistance or removal of dangling resistance and promoting that resistance to a global network to enable static timing characterization. Further, one or more embodiments of the present disclosure may manipulate a hierarchical parasitic netlist used for simulation of large, inherently hierarchical designs, for example, memory macros.

For example, FIG. 1A illustrates an example logical netlist 100 representing a memory module generated by a memory compiler. In electronic design, a netlist is a description of the connectivity of an electronic circuit and includes a list of the electronic components in a circuit and a list of the nodes they are connected to. A netlist may be a machine readable file that contains all the connections between all the components in an electronic circuit design. For example, memory compilers are software tools that build different types and configurations of memories from the leaf cells. Memory designers develop the leaf cells in a fashion to optimize reuse and to maximize the number of compiler configurations offered. The compilers place specific combinations of leaf cells in a hierarchical configuration to achieve the user's specification. Connectivity is made at the boundaries of the cells by simply abutting the cells, forming connections at pre-determined wiring locations at the sides or edges of the leaf cells.

For example, in FIG. 1A, a specific combination of a plurality of leaf cells 102, 104, 106, and 108 may be connected to each other at the boundaries of the cells forming connections at pre-determined wiring locations. For example, the input terminals of the leaf cells 102, 104, 106, and 108 may be connected together forming the netlist 100, however, the output terminals O[0], O[1], O[2], and O[3] of leaf cells 102, 104, 106, and 108 are not connected. In particular, the inputs to the leaf cells are shown as being located on the left edge of each leaf cell and are connected to corresponding taps from a shared input line 109 connected to input terminal 101 for signal W.

To accurately model the wiring resistances of the pre-placed wires of the leaf cells 102, 104, 106, and 108, extraction may be performed on the leaf cells 102, 104, 106, and 108. For example, FIG. 1B illustrates the netlist 100 with the extracted leaf cells 102, 104, 106, and 108 with corresponding, top, bottom, left, and right, labels annotated for each signal that passes from one edge to another into the physical layout of the leaf cells 102, 104, 106, and 108. In other words, while FIG. 1A shows that the inputs to the leaf cells are connected to taps from the shared input line 109 outside of the leaf cells, the shared input line 109 is actually implemented by through connections within the leaf cells, where an input to a leaf cell is connected to an output of its adjacent leaf cell. By convention :T, :B, :L, :R suffixes, here after referred to as TBLR labels, are added to the originating signal name and placed on the corresponding edge (e.g., the top, bottom, left, and right edges, respectively). For example, the W:L input pin of a leaf cell is connected to the W:R output pin of the leaf cell to its left. Extraction is then performed to capture all parasitic resistances and capacitances inside the leaf cells 102, 104, 106, and 108. For example, the parasitic resistances of the leaf cells 102, 104, 106, and 108 of FIG. 1B are represented as 110, 120, 130, and 140, respectively, and two terminals of each of the parasitic resistances 110, 120, 130, and 140 are labeled as L (or W:L) and R (or W:R). The extracted leaf cells 102, 104, 106, and 108 are then stitched together into a full instance netlist 100 for transient analysis.

STA tools use fast and substantially accurate approaches to estimate the delay of sub-circuits within the memory circuit and use graph analysis techniques to quickly seek out the slowest and fastest paths in the memory circuit. Although STA tools are much faster than a dynamic circuit simulator and do not require vectors or measurements, STA tools do not recognize or take into consideration wire-thru resistances inside the leaf cells, where the input load is modulated by the output load, making it difficult to characterize the leaf cell delay.

For example, during the transient analysis of the stitched netlist 100 of FIG. 1B, the STA tools used for transient analysis may not recognize the internal parasitic resistances 110, 120, 130, and 140 of the leaf cells 102, 104, 106, and 108 (e.g., passing capacitance on an output pin, backwards through the leaf cell to the input of the leaf cell) and therefore may inaccurately determine that the signals applied at the input terminal 101 of the netlist 100 arrives at the terminal 103 (e.g., the input terminal of the leaf cell 108) substantially instantaneously. In some approaches to static timing analysis, the static timing analysis stops upon reaching the first leaf cell 102, because the connection to the next leaf cell 104 is made at a lower level in the hierarchy of the netlist than the signal W being analyzed and supplied to the input terminal 101 (e.g., the connection is within the leaf cell and not at the higher level of the hierarchy of the netlist, at the level of the input terminal 101). This may introduce error in the timing analysis of the memory module or the netlist 100 and ultimately lead to a failure to validate that a design (e.g., the netlist 100) meets its design specifications by operating at a specific clock frequency without errors caused by a signal arriving too soon or too late, for example, because the static timing analysis may fail to generate information regarding the arrival times of the signal at leaf cells 104, 106, and 108.

This problem occurs in memory designs where the interconnect is placed inside the leaf cells (e.g., the leaf cells 102, 104, 106, and 108) and connections are made by abutment to nearest neighbors, in contrast to standard cell place and route where wires are located outside the leaf cells (and therefore the static timing analysis process analyzes the timing of the signal that passes along the wires outside the leaf cells and at a higher level of the hierarchy of circuit design).

In order to overcome the deficiencies of STA in performing timing analysis of a memory module, one or more embodiments of the present disclosure isolate the local wiring resistances and promote the local wiring resistances from inside a leaf cell to a level above the leaf cell to preserve the distributed nature of the network. Therefore, technical advantages of the present disclosure include improving accuracy of the STA results during transient analysis of a memory circuit and therefore improving the detection of critical timing paths and timing violations earlier in the design process for a memory circuit, without incurring the high cost and long turnaround times of simulation.

For example, according to one or more embodiments of the present disclosure, FIG. 1C illustrates the netlist 100, where the internal parasitic resistances 110, 120, 130, and 140 or the port-to-port TBLR resistances of the leaf cells 102, 104, 106, and 108 are isolated into separate resistances to be promoted to a level above the respective leaf cells. In FIG. 1C, the parasitic resistances 110, 120, 130, and 140 of the leaf cells 102, 104, 106, and 108 are illustrated as resistor circuits having two terminals. However, in one or more embodiments, parasitic resistances of the leaf cells may be represented as resistor circuits having three terminals, resistor circuits having four terminals, or resistor circuits having N number of terminals (where N is an integer).

For example, in FIG. 1C, the internal parasitic resistances 110, 120, 130, and 140 or the port-to-port TBLR resistances of the leaf cells 102, 104, 106, and 108 are represented by their respective equivalent resistances outside the respective leaf cell. This enables STA to recognize and take into consideration the internal parasitic resistances 110, 120, 130, and 140 of the leaf cells 102, 104, 106, and 108 by performing the timing analysis or transient analysis on the transformed or promoted equivalent resistances.

For example, if the pin-to-pin resistance corresponding to a two-port leaf cell from among the leaf cells 102, 104, 106, and 108 is represented as R_{LR}, equivalent resistance with respect to the left port (R_{L}) and equivalent resistance with respect to the right port (R_{R}) of the corresponding leaf cell may be represented as:

R_{L}=R_{R}=R_{LR}/2 (1).

For example, in case of the leaf cell 102, the equivalent resistances 112 and 114 of the internal parasitic resistance 110 having two terminals may be determined by equation 1. For example, the resistance value of each of the equivalent resistances 112 and 114 may be half of the resistance value of the parasitic resistance 110. Once the values of the equivalent resistances 112 and 114 for the internal parasitic resistance 110 of the leaf cell 102 are determined, the two port equivalent network having equivalent resistances 112 and 114 are promoted to the hierarchical level above the leaf cell 102. In this example, the left and right pins of the leaf cell 102 are shorted to a mid-point W of the equivalent network. The two ports (e.g., L and R) of the leaf cell 102 are connected together or connected to a common point W and equivalent resistances 112 and 114 are connected to the common point W outside the leaf cell 102.

Similarly, in case of the leaf cell 104, the equivalent resistances 122 and 124 of the internal parasitic resistance 120 having two terminals may be determined by equation 1. For example, the resistance value of each of the equivalent resistances 122 and 124 may be half of the resistance value of the parasitic resistance 120. Once the values of the equivalent resistances 122 and 124 for the internal parasitic resistance 120 of the leaf cell 104 are determined, the two port equivalent network having equivalent resistances 122 and 124 are promoted to the hierarchical level above the leaf cell 104. In this example, the left and right pins of the leaf cell 104 are shorted to a mid-point W of the equivalent network. The two ports (e.g., L and R) of the leaf cell 104 are connected together or connected to a common point W and equivalent resistances 122 and 124 are connected to the common point W outside the leaf cell 104.

In case of the leaf cell 106, the equivalent resistances 132 and 134 of the internal parasitic resistance 130 having two terminals may be determined by equation 1. For example, the resistance value of each of the equivalent resistances 132 and 134 may be half of the resistance value of the parasitic resistance 130. Once the values of the equivalent resistances 132 and 134 for the internal parasitic resistance 130 of the leaf cell 106 are determined, the two port equivalent network having equivalent resistances 132 and 134 are promoted to the hierarchical level above the leaf cell 106. In this example, the left and right pins of the leaf cell 106 are shorted to a mid-point W of the equivalent network. The two ports (e.g., L and R) of the leaf cell 106 are connected together or connected to a common point W and equivalent resistances 132 and 134 are connected to the common point W outside the leaf cell 106.

Further, in case of the leaf cell 108, the equivalent resistances 142 and 144 of the internal parasitic resistance 140 having two terminals may be determined by equation 1. For example, the resistance value of each of the equivalent resistances 142 and 144 may be half of the resistance value of the parasitic resistance 140. Once the values of the equivalent resistances 142 and 144 for the internal parasitic resistance 140 of the leaf cell 108 are determined, the two port equivalent network having equivalent resistances 142 and 144 are promoted to the hierarchical level above the leaf cell 108. In this example, the left and right pins of the leaf cell 108 are shorted to a mid-point W of the equivalent network. The two ports (e.g., L and R) of the leaf cell 108 are connected together or connected to a common point W and equivalent resistances 142 and 144 are connected to the common point W outside the leaf cell 108.

For example, FIG. 1C illustrates promoting a two port equivalent network to the hierarchical level above the leaf cell. The equivalent resistances 112, 114, 122, 124, 132, 134, 142, and 144 may be connected in series with each other outside the leaf cells 102, 104, 106, and 108 at the inputs of the leaf cells. Further, all TBLR pins of a port are shorted to the respective common node of the equivalent network shown. For example, the two or more ports of the leaf cell (e.g., the leaf cell 102) are connected together or connected to a common point (e.g., W) and equivalent resistances (e.g., 112, 114) are connected to the common point (e.g., W) outside the leaf cell (e.g., the leaf cell 102). Because in the netlist 100 of FIG. 1C, the equivalent resistances 112, 114, 122, 124, 132, 134, 142, and 144 corresponding to the internal parasitic resistances 110, 120, 130, and 140 of the leaf cells 102, 104, 106, and 108 are connected outside the leaf cells 102, 104, 106, and 108 at the inputs of the leaf cells, during the transient analysis of the netlist 100 of FIG. 1C, the STA tool will recognize the equivalent resistances 112, 114, 122, 124, 132, 134, 142, and 144 and therefore generate timing analysis and transient analysis results that accurately account for the corresponding internal resistances of the actual wire connection that was formed by abutting the leaf cells.

In the embodiment of FIG. 1C, the left and right pins of the leaf cells are shorted to a mid-point of the equivalent network. Shorting the TBLR ports avoids double counting of the wiring resistances. Further, while the promoted network is not an exact equivalent circuit, however, it is a very good approximation suitable for embedded wire thru applications and sufficient to detect potential timing violations.

Therefore, during the timing analysis or transient analysis of the netlist 100 of FIG. 1C, the STA tool may break down the netlist 100 into timing paths, substantially accurately calculate the signal propagation delay along each path, and check for violations of timing constraints inside the design and at the input/output interface.

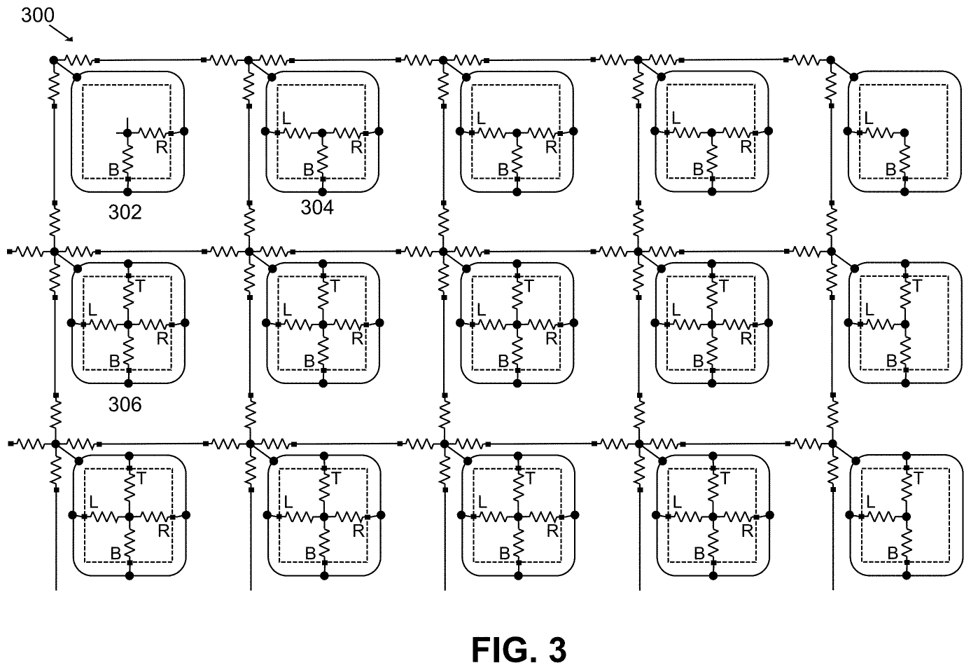

FIG. 2 illustrates a method for determining equivalent resistances of a leaf cell of a netlist of a memory module and promoting the equivalent resistances to a hierarchical level above the leaf cell for transient analysis of the netlist according to one embodiment of the present disclosure.

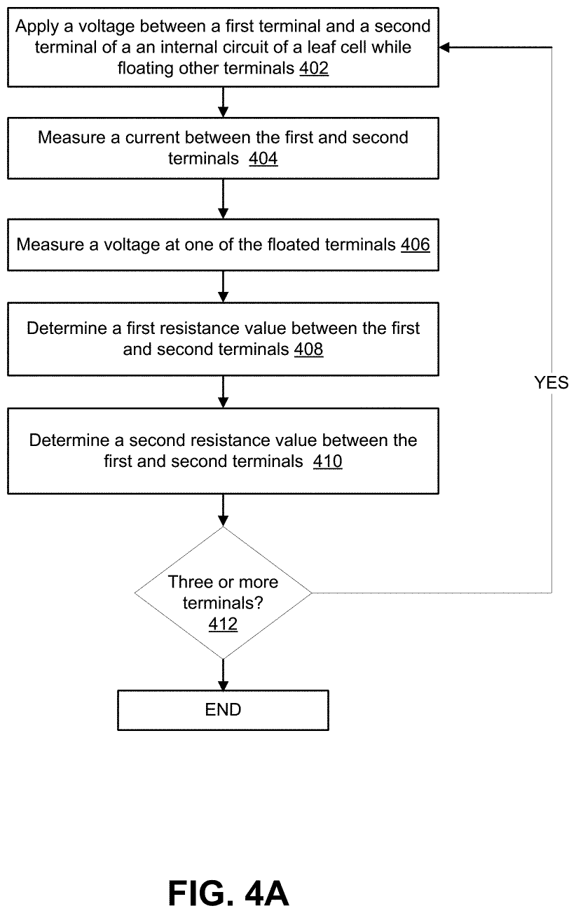

For example, to isolate a port-to-port resistance of a leaf cell, at 202, for each port that has TBLR suffixes, port to port resistances between each suffix are determined. This will be further discussed with respect to FIG. 3.

For example, FIG. 3 illustrates a netlist 300 with a plurality of extracted leaf cells with corresponding, top, bottom, left and right, labels annotated for each signal that passes from one edge to another into the physical layout of the leaf cells according to one embodiment of the present disclosure. As discussed with respect to FIG. 1B, by convention :T (top), :B (bottom), :L (left), :R (right) suffixes, hereafter referred to as TBLR labels, are added to the originating signal name and placed on the corresponding edge. Extraction is then performed to capture all parasitic resistances inside the leaf cells. For example, terminals of each of the parasitic resistances are labeled as B, R, L, or T. For example, in order to isolate a port to port resistance of a leaf cell, at 202, port to port resistances between terminals of an internal circuit of the leaf cell is determined. For example, a resistance between the terminals B and R of the leaf cell 302 is determined. For example, in order to isolate a port to port resistance of a leaf cell 304, at 202, the resistances between the terminals B and R, B and L, and L and R, are determined. Further, in order to isolate a port to port resistance of a leaf cell 306, at 202, the resistances between the terminals B and R, B and L, L and R, L and T, and T and R, are determined.

Resistances can be determined by applying a small voltage across the two pins to be measured while floating the other pins, running a DC simulation, and measuring the current. The resistance R can be calculated using Ohm's law (e.g., V=IR, where V is a voltage between two terminals of a resistance and I is the current through the resistor) by dividing the applied voltage by the measured current. This process is repeated for each suffix combination and again for each port having TBLR suffixes.

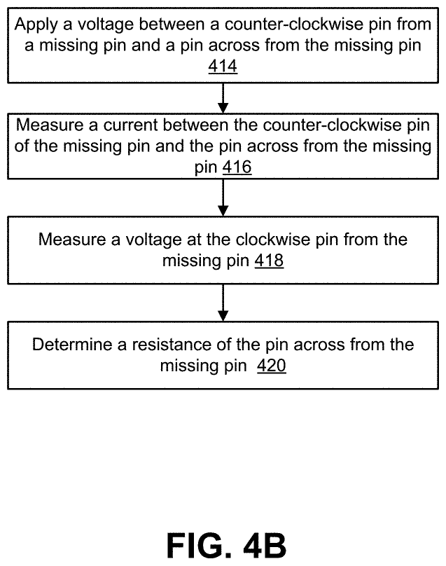

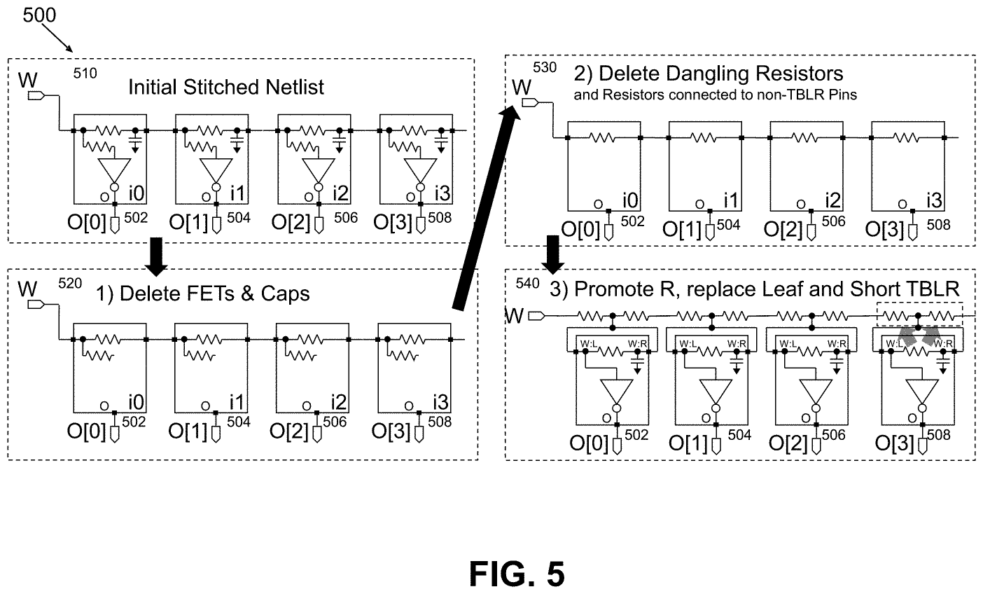

For example, FIG. 4A illustrates a method for determining values of parasitic resistances inside a leaf cell according to one embodiment of the present disclosure.

For example, to determine the resistance values of the parasitic resistances L, T, R, and B, of a leaf cell, first at 402, a voltage is applied between a first terminal and a second terminal of an internal circuit of a leaf cell while floating the other one or more terminals. For example, to determine the resistance values of the parasitic resistors L, T, R, and B of the leaf cell 306, a voltage is applied between the L pin and the R pin, while floating the T and B pins.

Next, at 404, a current between the first and second terminals is measured. For example, at 404, the current between the pins L and R is measured.

At 406, a voltage at one of the floated terminals is measured. For example, at 406, a voltage at either T pin or B pin of the leaf cell 306 is measured.

At 408, a first resistance value between the first and second terminals is determined by dividing the measured voltage at one of the floated terminals (e.g., 406) by the measured current between the first and second terminals (e.g., 404). For example, R resistance of the leaf cell 306 is determined by dividing the voltage measured at either T pin or B pin (e.g., 406) by the current measured between the pins L and R (404).

At 410, a second resistance value between the first and second terminals is determined by dividing the voltage applied between the first and second terminals (e.g., 402) by the measured current between the first and second terminals (e.g., 404) and then subtracting the first resistance value from the result. For example, L resistance of the leaf cell 306 is measured by dividing the voltage applied between the L pin and the R pin (e.g., 402) by the current measured between the pins L and R (404) and then subtracting the R resistance from the result.

Next, at 412, if it is determined that the internal circuit representing a leaf cell has three or more terminals, other parasitic resistances may be determined by repeating 402 to 410 for each pair of terminals. For example, because the internal circuit representing the parasitic resistance of the leaf cell 306 has four terminals, the resistances of the parasitic resistors T and B are determined by repeating 402 to 410.

However, if in an internal parasitic resistor circuit of a leaf cell (e.g., leaf cell 304), a terminal (e.g., from among L, T, R, and B) does not exist, FIG. 4B illustrates a method of determining resistance at the pin across from the missing pin.

In the method of FIG. 4B, at 414, a voltage is applied between a counter-clockwise pin from the missing pin and a pin across from the missing pin. For example, in case of the leaf cell 304, because pin T is missing, a voltage is applied between pin L that is counter-clockwise from the missing pin T and pin B that is across from the missing pin T.

Next, at 416, a current between the counter-clockwise pin of the missing pin and the pin across from the missing pin is measured. For example, a current between pin L that is counter-clockwise from the missing pin T and the pin B that is across from the missing pin T is measured.

Next, at 418, a voltage at the clockwise pin from the missing pin is measured. For example, a voltage is measured at pin R that is clockwise from the missing pin T.

At 420, a resistance of the pin across from the missing pin may be determined by dividing the voltage at the clockwise pin from the missing pin by the current between the counter-clockwise pin of the missing pin and the pin across from the missing pin, and subtracting the resistance of the counter-clockwise pin calculated in 402 to 412. For example, resistance of the pin B across from the missing pin T may be determined by dividing the voltage at the clockwise pin R from the missing pin T by the current between pin L that is counter-clockwise of the missing pin T and pin B that is across from the missing pin T, and subtracting the resistance of the counter-clockwise pin L calculated in 402 to 412.

Now, returning back to FIG. 2, once the resistances of the internal parasitic resistors of a leaf cell is determined using the methods of FIGS. 4A-4B, at 204, the resistance values are used to generate an equivalent network corresponding to each leaf cell.

For example, determining the equivalent network for the parasitic resistances of a leaf cell where the parasitic resistances are represented by a resistor circuit having two terminals, is discussed with respect to FIG. 1C. However, when the parasitic resistances of a leaf cell (e.g., leaf cell 304) are represented by a resistor circuit having three terminals, given the pin-to-pin resistances R_{LR}, R_{LT}, R_{TR}, and R_{RL} corresponding to a three-terminal leaf cell, equivalent resistances going to the left (R_{L}), right (R_{R}) and top (R_{T}) pins may be represented as:

R_{L}=(R_{LT}+R_{LR}−R_{TR})/2 (2),

R_{R}=(R_{RT}+R_{LR}−R_{TL})/2 (3), and

R_{T}=(R_{TL}+R_{TR}−R_{LR})/2 (4).

Further, when the parasitic resistances of a leaf cell (e.g., leaf cell 304) are represented by a resistor circuit having four terminals, given the pin-to-pin resistances R_{LR}, R_{LT}, R_{TR}, R_{RL}, R_{BL}, and R_{BR} corresponding to a four-terminal leaf cell, equivalent resistances going to the left, right, and top pins may be represented by the above expressions (2), (3), and (4) corresponding to the three-terminal network. The equivalent resistance going to the bottom pin (R_{B}) may be represented as:

R_{B}=(R_{BL}+R_{BR}−R_{LR})/2 (5).

The equivalent network created for each leaf cell based on the equations (1) to (5), may have a central node W (e.g., FIG. 1C).

At 206, the equivalent network is promoted to a hierarchical level above the leaf cell. For example, once the value of the equivalent resistances for the internal parasitic resistances of the leaf cells are determined, the two or more ports equivalent network having equivalent resistances are promoted to the hierarchical level above the leaf cells (e.g., as discussed with respect to FIG. 1C). For example, as shown in FIG. 1C, the equivalent resistances 112, 114, 122, 124, 132, 134, 142, and 144 may be connected in series with each other outside the leaf cells at the inputs of the leaf cells. Because in the netlist 100 of FIG. 1C, the equivalent resistances 112, 114, 122, 124, 132, 134, 142, and 144 corresponding to the internal parasitic resistances 110, 120, 130, and 140 of the leaf cells 102, 104, 106, and 108 are connected outside the leaf cells 102, 104, 106, and 108 at the inputs of the leaf cells, during the transient analysis of the netlist 100 of FIG. 1C, the STA tool will recognize the equivalent resistances 112, 114, 122, 124, 132, 134, 142, and 144. Therefore, during the timing analysis or transient analysis of the netlist 100 of FIG. 1C, the STA tool may break down the netlist 100 into timing paths, substantially accurately calculate the signal propagation delay along each path, and check for violations of timing constraints inside the design and at the input/output interface.

At 208, all the terminals of the leaf cell are shorted to a central node of the equivalent network. For example, all the pins (e.g., TBLR) of the leaf cell (e.g., the leaf cell 102) are shorted to a mid-point (e.g., W) of the equivalent network. The two or more ports of the leaf cell (e.g., the leaf cell 102) are connected together or connected to a common point (e.g., W) and equivalent resistances (e.g., 112, 114) are connected to the common point (e.g., W) outside the leaf cell (e.g., the leaf cell 102). Shorting the TBLR ports avoids double counting of the wiring resistances.

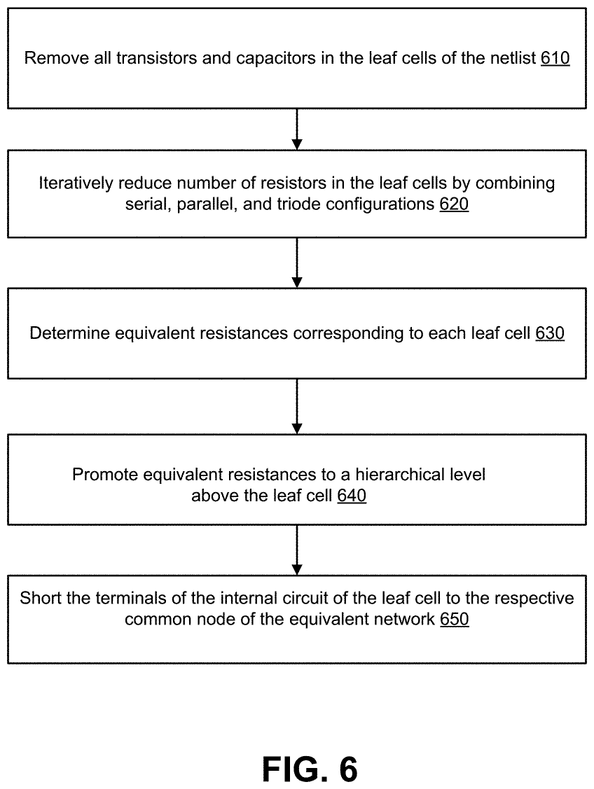

FIGS. 5 and 6 illustrate a circuit and a flowchart of a method to transform local wire through resistances into global distributed resistances in a logical netlist of leaf cells according to one embodiment of the present disclosure. According to one or more embodiments, the method of FIGS. 5-6 is a circuit topology reduction technique.

The method of FIGS. 5-6 is applied to a netlist 500 with extracted leaf cells 502, 504, 506, and 508. The extracted the netlist including the leaf cells shown in 510 of FIG. 5 may be similar to the netlist with extracted leaf cells of FIG. 1B.

For example, to transform local wire through resistances into global distributed resistances in a logical netlist of leaf cells, at 610, all the transistors and the capacitors in the leaf cells of the netlist are removed. For example, as shown in 520, all the transistors and the capacitors in the leaf cells 502, 504, 506, and 508 of the netlist are removed. As a result, only resistors will be left in the leaf cells 502, 504, 506, and 508 of the circuit design.

At 620, the number of resistors in the leaf cells are iteratively reduced by combining serial, parallel, and triode resistor configurations. For example, as shown in 530, dangling resistors are removed from the leaf cells 502, 504, 506, and 508 until only the port-to-port resistors remain to a common node. In one or more embodiments, reducing the network of resistors may include transforming a delta-circuit into a Y-circuit. For example, given the resistances Ra, Rb, and Rc corresponding to a delta-circuit, resistances R1, R2, and R3 of the equivalent Y circuit may be represented as:

R1=RbRc/(Ra+Rb+Rc)

R2=RaRc/(Ra+Rb+Rc), and

R3=RaRb/(Ra+Rb+Rc).

Once the resistors in the leaf cells are iteratively reduced by combining serial, parallel, and triode configurations, at 630, equivalent resistances of the remaining internal resistances of the leaf cell is determined. The internal circuit includes one or more remaining resistors after the iterative reduction of the resistors in the leaf cell is performed.

For example, equivalent resistances of the leaf cell may be determined based on the methods discussed with respect to FIGS. 4A-4B.

Next, at 640, the equivalent resistances are promoted to a hierarchical level above the leaf cell. For example, as shown in 540, once the value of the equivalent resistances for the internal parasitic resistances of the leaf cells 502, 504, 506, and 508 are determined (e.g., at 630), the two or more ports equivalent network having equivalent resistances are promoted to the hierarchical level above the leaf cells 502, 504, 506, and 508.

At 650, all the pins (e.g., TBLR) of the leaf cell are shorted to a mid-point of the equivalent network. For example, as shown in 540, the TBLR ports of the leaf cells 502, 504, 506, and 508 are shorted to the common node of the equivalent network. The two or more ports of the leaf cells are connected together or connected to a common point and equivalent resistances are connected to the common point outside the corresponding leaf cell. Shorting the TBLR ports avoids double counting of the wiring resistances.

For example, once the value of the equivalent resistances for the internal parasitic resistances of the leaf cells are determined, the two or more ports equivalent network having equivalent resistances are promoted to the hierarchical level above the leaf cells For example, as shown in FIG. 5, the equivalent resistances may be connected in series with each other outside the leaf cells 502, 504, 506, and 508 at the inputs of the leaf cells 502, 504, 506, and 508. Because in the netlist 500 of FIG. 5, the equivalent resistances corresponding to the internal parasitic resistances of the leaf cells 502, 504, 506, and 508 are connected outside the leaf cells 502, 504, 506, and 508 at the inputs of the leaf cells, during the transient analysis of the netlist 500 of FIG. 5, the STA tool will recognize the equivalent resistances. Therefore, during the timing analysis or transient analysis of the netlist 500 of FIG. 5, the STA tool may break down the netlist 500 into timing paths, substantially accurately calculate the signal propagation delay along each path, and check for violations of timing constraints inside the design and at the input/output interface.

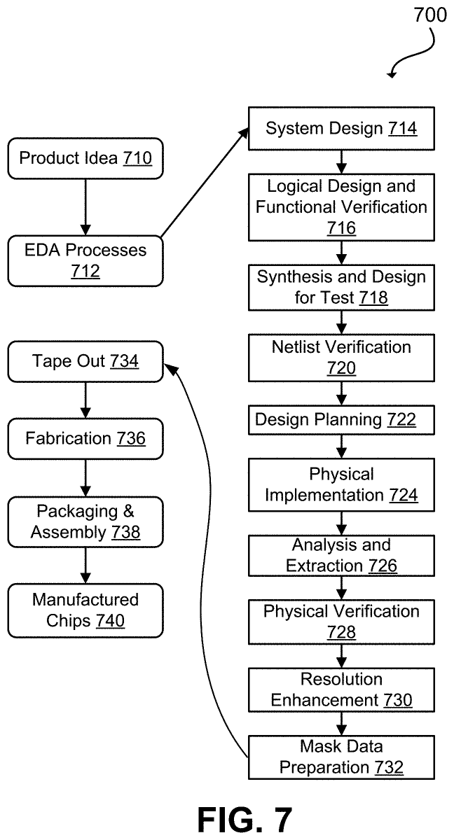

FIG. 7 illustrates an example set of processes 700 used during the design, verification, and fabrication of an article of manufacture such as an integrated circuit to transform and verify design data and instructions that represent the integrated circuit. Each of these processes can be structured and enabled as multiple modules or operations. The term ‘EDA’ signifies the term ‘Electronic Design Automation.’ These processes start with the creation of a product idea 710 with information supplied by a designer, information which is transformed to create an article of manufacture that uses a set of EDA processes 712. When the design is finalized, the design is taped-out 734, which is when artwork (e.g., geometric patterns) for the integrated circuit is sent to a fabrication facility to manufacture the mask set, which is then used to manufacture the integrated circuit. After tape-out, a semiconductor die is fabricated 736 and packaging and assembly processes 738 are performed to produce the finished integrated circuit 740.

Specifications for a circuit or electronic structure may range from low-level transistor material layouts to high-level description languages. A high-level of representation may be used to design circuits and systems, using a hardware description language (‘HDL’) such as VHDL, Verilog, SystemVerilog, SystemC, MyHDL or OpenVera. The HDL description can be transformed to a logic-level register transfer level (‘RTL’) description, a gate-level description, a layout-level description, or a mask-level description. Each lower representation level that is a more detailed description adds more useful detail into the design description, for example, more details for the modules that include the description. The lower levels of representation that are more detailed descriptions can be generated by a computer, derived from a design library, or created by another design automation process. An example of a specification language at a lower level of representation language for specifying more detailed descriptions is SPICE, which is used for detailed descriptions of circuits with many analog components. Descriptions at each level of representation are enabled for use by the corresponding systems of that layer (e.g., a formal verification system). A design process may use a sequence depicted in FIG. 7. The processes described by be enabled by EDA products (or EDA systems).

During system design 714, functionality of an integrated circuit to be manufactured is specified. The design may be optimized for desired characteristics such as power consumption, performance, area (physical and/or lines of code), and reduction of costs, etc. Partitioning of the design into different types of modules or components can occur at this stage.

During logic design and functional verification 716, modules or components in the circuit are specified in one or more description languages and the specification is checked for functional accuracy. For example, the components of the circuit may be verified to generate outputs that match the requirements of the specification of the circuit or system being designed. Functional verification may use simulators and other programs such as testbench generators, static HDL checkers, and formal verifiers. In some embodiments, special systems of components referred to as ‘emulators’ or ‘prototyping systems’ are used to speed up the functional verification.

During synthesis and design for test 718, HDL code is transformed to a netlist. In some embodiments, a netlist may be a graph structure where edges of the graph structure represent components of a circuit and where the nodes of the graph structure represent how the components are interconnected. Both the HDL code and the netlist are hierarchical articles of manufacture that can be used by an EDA product to verify that the integrated circuit, when manufactured, performs according to the specified design. The netlist can be optimized for a target semiconductor manufacturing technology. Additionally, the finished integrated circuit may be tested to verify that the integrated circuit satisfies the requirements of the specification.

During netlist verification 720, the netlist is checked for compliance with timing constraints and for correspondence with the HDL code. During design planning 722, an overall floor plan for the integrated circuit is constructed and analyzed for timing and top-level routing.

During layout or physical implementation 724, physical placement (positioning of circuit components such as transistors or capacitors) and routing (connection of the circuit components by multiple conductors) occurs, and the selection of cells from a library to enable specific logic functions can be performed. As used herein, the term ‘cell’ may specify a set of transistors, other components, and interconnections that provides a Boolean logic function (e.g., AND, OR, NOT, XOR) or a storage function (such as a flipflop or latch). As used herein, a circuit ‘block’ may refer to two or more cells. Both a cell and a circuit block can be referred to as a module or component and are enabled as both physical structures and in simulations. Parameters are specified for selected cells (based on ‘standard cells’) such as size and made accessible in a database for use by EDA products.

During analysis and extraction 726, the circuit function is verified at the layout level, which permits refinement of the layout design. During physical verification 728, the layout design is checked to ensure that manufacturing constraints are correct, such as DRC constraints, electrical constraints, lithographic constraints, and that circuitry function matches the HDL design specification. During resolution enhancement 730, the geometry of the layout is transformed to improve how the circuit design is manufactured.

During tape-out, data is created to be used (after lithographic enhancements are applied if appropriate) for production of lithography masks. During mask data preparation 732, the ‘tape-out’ data is used to produce lithography masks that are used to produce finished integrated circuits.

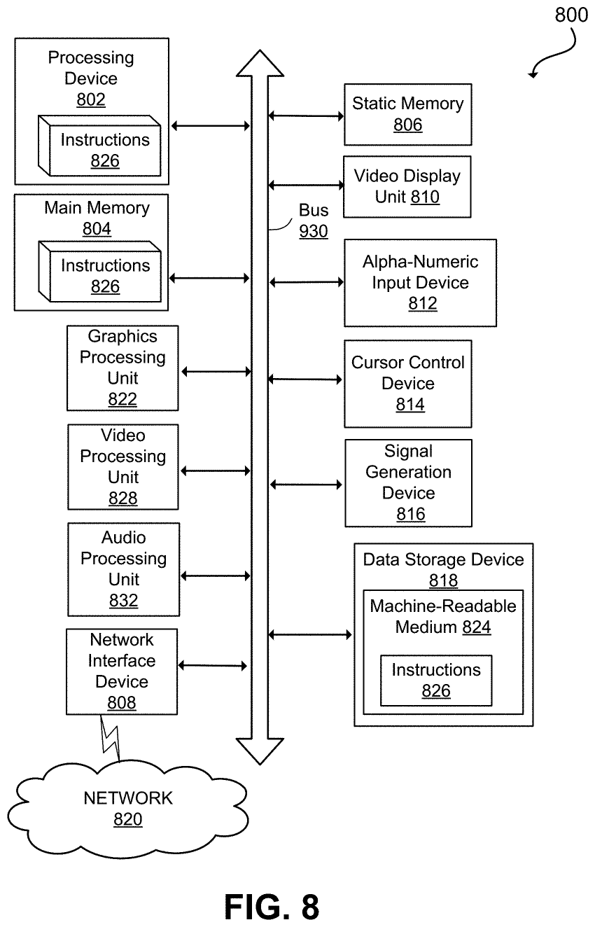

A storage subsystem of a computer system (such as computer system 900 of FIG. 9, or host system 807 of FIG. 8) may be used to store the programs and data structures that are used by some or all of the EDA products described herein, and products used for development of cells for the library and for physical and logical design that use the library.

FIG. 8 illustrates an example machine of a computer system 900 within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 900 includes a processing device 802, a main memory 804 (e.g., read-only memory (ROM), flash memory, dynamic random access memory (DRAM) such as synchronous DRAM (SDRAM), a static memory 806 (e.g., flash memory, static random access memory (SRAM), etc.), and a data storage device 818, which communicate with each other via a bus 930.

Processing device 802 represents one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 802 may also be one or more special-purpose processing devices such as an application specific integrated circuit (ASIC), a field programmable gate array (FPGA), a digital signal processor (DSP), network processor, or the like. The processing device 802 may be configured to execute instructions 926 for performing the operations and steps described herein.

The computer system 800 may further include a network interface device 808 to communicate over the network 820. The computer system 800 also may include a video display unit 810 (e.g., a liquid crystal display (LCD) or a cathode ray tube (CRT)), an alphanumeric input device 812 (e.g., a keyboard), a cursor control device 814 (e.g., a mouse), a graphics processing unit 822, a signal generation device 816 (e.g., a speaker), graphics processing unit 822, video processing unit 828, and audio processing unit 832.

The data storage device 818 may include a machine-readable storage medium 824 (also known as a non-transitory computer-readable medium) on which is stored one or more sets of instructions 826 or software embodying any one or more of the methodologies or functions described herein. The instructions 826 may also reside, completely or at least partially, within the main memory 804 and/or within the processing device 802 during execution thereof by the computer system 800, the main memory 804 and the processing device 902 also constituting machine-readable storage media.

In some implementations, the instructions 826 include instructions to implement functionality corresponding to the present disclosure. While the machine-readable storage medium 824 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine and the processing device 802 to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

The present disclosure may be provided as a computer program product, or software that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. Where the disclosure refers to some elements in the singular tense, more than one element can be depicted in the figures and like elements are labeled with like numerals. The disclosure and drawings are, accordingly, to be regarded in an illustrative sense rather than a restrictive sense.

What is claimed is:

1. A method for transient analysis of a memory module circuit, the method comprising:
determining port to port resistances between terminals of internal circuits of a plurality of leaf cells of a netlist representing the memory module circuit;
generating a plurality of equivalent networks corresponding to the internal circuits of the leaf cells, the equivalent networks being connected to each other;
promoting the equivalent networks of the leaf cells to a hierarchical level above the leaf cells in the netlist representing the memory module circuit;
shorting one or more terminals of each of the leaf cells to a central node of a corresponding one of the equivalent networks; and
performing the transient analysis of the leaf cells of the netlist representing the memory module circuit.

2. The method of claim 1,
wherein the internal circuits of the leaf cells comprise one or more parasitic resistances of the leaf cells, and
wherein the equivalent networks comprise one or more equivalent resistances corresponding to the one or more parasitic resistances of the leaf cells.

3. The method of claim 2, wherein promoting the equivalent networks of the leaf cells comprises connecting the one or more equivalent resistances corresponding to the one or more parasitic resistances of the leaf cells outside the leaf cells at inputs of the leaf cells.

4. The method of claim 1, wherein the port to port resistances between the terminals of the internal circuits of the leaf cells are determined based on a DC simulation of the leaf cells by:
applying a voltage between a first terminal and a second terminal of each of the internal circuits of the leaf cells to determine an applied voltage and floating one or more other terminals of each of the internal circuits of the leaf cells;
measuring a current between the first and second terminals of each of the internal circuits of the leaf cells to determine a measured current;
measuring a voltage at one of the one or more floated terminals of each of the internal circuits of the leaf cells to determine a measured voltage;
determining a first resistance value between the first and second terminals by dividing the measured voltage by the measured current; and
determining a second resistance value between the first and second terminals by dividing the applied voltage by the measured current and subtracting the first resistance value from a result from the division.

5. The method of claim 4, further comprising:
applying a voltage between a third terminal and a fourth terminal of each of the internal circuits of the leaf cells to determine a second applied voltage and floating one or more of the first and second terminals of each of the internal circuits of the leaf cells;
measuring a current between the third and fourth terminals of each of the internal circuits of the leaf cells to determine a second measured current;
measuring a voltage at one of the one or more floated first and second terminals of each of the internal circuits of the leaf cells to determine a second measured voltage;
determining a third resistance value between the third and fourth terminals by dividing the second measured voltage by the second measured current; and
determining a fourth resistance value between the third and fourth terminals by dividing the second applied voltage by the second measured current and subtracting the third resistance value from a second result from the division.

6. The method of claim 4, further comprising:
determining that an internal circuit from among the internal circuits of the leaf cells is missing a third terminal;
applying a voltage between a counter-clockwise terminal from among the first terminal, the second terminal, and a fourth terminal of the internal circuit of the leaf cell and a terminal from among the first, second, and third terminals that is across from the missing third terminal, the counter-clockwise terminal being in a counter-clockwise position from the missing third terminal;
measuring a current between the counter-clockwise terminal and the terminal across from the missing third terminal;
measuring a voltage at a clockwise terminal from among the first, second, and fourth terminals, the clockwise terminal being in a clockwise position from the missing third terminal; and
determining a resistance of the terminal across from the missing third terminal by dividing the voltage at the clockwise terminal by the current between the counter-clockwise terminal and the terminal across from the missing third terminal, and subtracting a resistance of the counter-clockwise terminal from a third result of the division.

7. A system for transient analysis of a memory module circuit, the system comprising:
a memory storing instructions; and
a processor, coupled with the memory and to execute the instructions, the instructions when executed cause the processor to:
remove one or more transistors and capacitors in each of a plurality of leaf cells of a netlist representing the memory module circuit;
iteratively reduce number of resistors in each of the leaf cells by at least removing dangling resistors;
generate equivalent networks corresponding to internal circuits of the leaf cells;
promote the equivalent networks of the leaf cells to a hierarchical level above the leaf cells in the memory module circuit; and
perform the transient analysis of the leaf cells of the netlist representing the memory module circuit.

8. The system of claim 7, wherein the processor is further configured to:
determine the internal circuits of the leaf cells, each of the internal circuits comprising one or more remaining resistors after the iterative reduction of the resistors in each of the leaf cells.

9. The system of claim 7, wherein a total number of resistors in each of the leaf cells are further iteratively reduced by combining serial, parallel, and triode resistor configurations in the internal circuits of each of the leaf cells.

10. The system of claim 7, wherein the processor is further configured to:
determine port to port resistances between terminals of the internal circuits of the leaf cells; and
short one or more terminals of each of the leaf cells to a central node of a corresponding one of the equivalent networks.

11. The system of claim 10, wherein the equivalent networks corresponding to the internal circuits of the leaf cells are generated based on the port to port resistances between the terminals of the internal circuits of the leaf cells.

12. The system of claim 10, wherein the internal circuits of the leaf cells comprise one or more parasitic resistances of the leaf cells, and
wherein the equivalent networks comprise one or more equivalent resistances corresponding to the one or more parasitic resistances of the leaf cells.

13. The system of claim 12, wherein promoting the equivalent networks of the leaf cells comprises connecting the one or more equivalent resistances corresponding to the one or more parasitic resistances of the leaf cells outside the leaf cells at an input of each of the leaf cells.

14. The system of claim 10, wherein to determine the port to port resistances between the terminals of the internal circuits of the leaf cells based on a DC simulation of the leaf cells, the processor is configured to:
apply a voltage between a first terminal and a second terminal of each of the internal circuits of the leaf cells to determine an applied voltage;
float one or more other terminals of each of the internal circuits of the leaf cells;
measure a current between the first and second terminals of each of the internal circuits of the leaf cells to determine a measured current; and
measure a voltage at one of the one or more floated terminals of each of the internal circuits of the leaf cells to determine a measured voltage.

15. The system of claim 14, wherein the processor is further configured to:
determine a first resistance value between the first and second terminals by dividing the measured voltage by the measured current; and
determine a second resistance value between the first and second terminals by dividing the applied voltage by the measured current and subtracting the first resistance value from a result from the division.

16. The system of claim 15, wherein the processor is further configured to:
apply a voltage between a third terminal and a fourth terminal of each of the internal circuits of the leaf cells to determine a second applied voltage;
float one or more of the first terminal and the second terminal of each of the internal circuits of the leaf cells;
measure a current between the third and fourth terminals of each of the internal circuits of the leaf cells to determine a second measured current;
measure a voltage at one of the one or more floated first and second terminals of each of the internal circuits of the leaf cells to determine a second measured voltage;
determine a third resistance value between the third and fourth terminals by dividing the second measured voltage by the second measured current; and
determine a fourth resistance value between the third and fourth terminals by dividing the second applied voltage by the second measured current and subtracting the third resistance value from a second result from the division.

17. The system of claim 15, wherein the processor is further configured to:
determine that an internal circuit from among the internal circuits of the leaf cells is missing a third terminal;
apply a voltage between a counter-clockwise terminal from among the first terminal, the second terminal, and a fourth terminal of the internal circuit of the leaf cell and a terminal from among the first, second, and third terminals that is across from the missing third terminal, the counter-clockwise terminal being in a counter-clockwise position from the missing third terminal;
measure a current between the counter-clockwise terminal and the terminal across from the missing third terminal;
measure a voltage at a clockwise terminal from among the first, second, and fourth terminals, the clockwise terminal being in a clockwise position from the missing third terminal; and
determine a resistance of the terminal across from the missing third terminal by dividing the voltage at the clockwise terminal by the current between the counter-clockwise terminal and the terminal across from the missing third terminal, and subtracting a resistance of the counter-clockwise terminal from a third result of the division.

18. A non-transitory computer readable medium comprising stored instructions, which when executed by a processor, cause the processor to:
generate equivalent networks corresponding to internal circuits of a plurality of leaf cells of a netlist representing a memory module circuit;
promote the equivalent networks of the leaf cells to a hierarchical level above the leaf cells in the memory module circuit; and
perform a transient analysis of the leaf cells of the netlist representing the memory module circuit.

19. The non-transitory computer readable medium of claim 18, wherein the processor is further configured to:
determine port to port resistances between terminals of the internal circuits of the leaf cells; and
short one or more terminals of each of the leaf cells to a central node of a corresponding one of the equivalent networks,
wherein the internal circuits of the leaf cells comprise one or more parasitic resistances of the leaf cells,
wherein the equivalent networks comprise one or more equivalent resistances corresponding to the one or more parasitic resistances of the leaf cells, and
wherein promoting the equivalent networks of the leaf cells comprise connecting the one or more equivalent resistances corresponding to the one or more parasitic resistances of the leaf cells outside the leaf cells at inputs of the leaf cells.

20. The non-transitory computer readable medium of claim 18, wherein to determining the port to port resistances between the terminals of the internal circuits of the leaf cells based on a DC simulation of the leaf cells, the processor is further configured to:
apply a voltage between a first terminal and a second terminal of each of the internal circuits of the leaf cells to determine an applied voltage;
float one or more other terminals of each of the internal circuits of the leaf cells;
measure a current between the first and second terminals of each of the internal circuits of the leaf cells to determine a measured current;
measure a voltage at one of the one or more floated terminals of each of the internal circuits of the leaf cells to determine a measured voltage;
determine a first resistance value between the first and second terminals by dividing the measured voltage by the measured current; and
determine a second resistance value between the first and second terminals by dividing the applied voltage by the measured current and subtracting the first resistance value from a result from the division.
